(19) United States
(12) Patent Application Publication
(10) Pub. No.: US 2008/0263859 A1
(43) Pub. Date: Oct. 30, 2008

(54) Hand Tool and Coaxial Connector Crimping Component Thereof

(76) Inventors: Chih-Lang Wang, Tu Cheng City (TW); Hsing-Chieh Ho, Tu Cheng City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/828,398

(22) Filed: Jul. 26, 2007

(30) Foreign Application Priority Data
Apr. 25, 2007 (TW) 096206604

(51) Int. Cl. B23P 19/00; H01R 12/00

(52) U.S. Cl. 29/751; 439/66; 29/828; 29/758

(57) ABSTRACT

A coaxial connector crimping component connects to a hand tool body to form a hand tool. The hand tool is used for crimping together a coaxial cable and a coaxial terminal. The coaxial connector crimping component has a plurality of crimping areas. One of the crimping areas is connected to the hand tool body, and at least one of the crimping areas can be alternatively connected to the hand tool body.

### BACKGROUND OF THE INVENTION

1. Field of the Invention

The present invention relates to a coaxial connector crimping component, and, more particularly, to a coaxial connector crimping component for crimping together coaxial cable with various types of coaxial terminals.

2. Description of the Related Art

Coaxial cable is a very common component in electronic products, and the wire within the coaxial cable may be used to transmit signals. When coaxial cable is connected to a terminal plug, a coaxial terminal is inserted between the coaxial cable and the terminal plug. The coaxial terminal may have different types to match the various types of terminal plugs. For example, F-type coaxial terminals, BNC-type coaxial terminals, RCA-type coaxial terminals, and IEC-type coaxial terminals all have different shapes.

When a user desires to connect together coaxial cable with a coaxial terminal, a hand tool is utilized to performing a crimping process. When the coaxial terminal is firmly attached to the terminal plug, the wire within the coaxial cable can send and receive signals via the coaxial terminal. The coaxial terminal thus provides a stable electrical connection.

There are some prior art hand tools for crimping together coaxial cable and coaxial terminals. The prior art hand tool comprises a coaxial connector crimping component which are screwed onto the hand tool body. When the hand tool is used for crimping together a different type or different specification of coaxial terminal, a matching coaxial connector crimping component must be swapped in using a screw driver. Although the coaxial connector crimping component for the hand tool can be swapped out, for each changing of the coaxial connector crimping component the user must use a screw driver, and one coaxial connector crimping component matches only one corresponding coaxial terminal. As a result, the number of coaxial terminals equals the number of coaxial connector crimping components, which increases costs and consumes a great deal of space.

A prior art coaxial connector crimping component with two crimping heads has been disclosed. For example, R.O.C. publication No. M275620, entitled “Crimping Head for a Coaxial Connector Crimping Tool”, discloses a single coaxial connector crimping component having two crimping areas. The user may directly switch the coaxial connector crimping component from one end to the other end by way of a plug-and-pull method to perform crimping for different types of coaxial terminals. However, only two different crimping areas are provided, and a single point connects the coaxial connector crimping component to the hand tool body, so the crimping component is not very stable when using. Also, as there are many different types of the coaxial terminals, providing only two crimping areas is insufficient.

Therefore, it is desirable to provide a coaxial connector crimping component having several different crimping areas to mitigate and/or obviate the aforementioned problems.

### SUMMARY OF THE INVENTION

An objective of the present invention is to provide a coaxial connector crimping component for crimping a coaxial cable and a coaxial terminal, and this coaxial connector crimping component is suitable for different types of coaxial terminals.

Another objective of the present invention is to provide a hand tool for crimping a coaxial cable and a coaxial terminal, and this hand tool is suitable for different types of coaxial terminals.

In order to achieve the objective, the coaxial connector crimping component of the present invention is capable of connecting to a hand tool body to form a hand tool, the hand tool being used for crimping together a coaxial cable and a coaxial terminal. The coaxial connector crimping component comprises: a plurality of crimping areas, one of the crimping areas being connected to the hand tool body, and at least one of the crimping areas capable of being alternatively connected to the hand tool body.

In order to achieve another objective, the hand tool of the present invention comprises a hand tool body and a coaxial connector crimping component connected to the hand tool body. The coaxial connector crimping component comprises: a plurality of crimping areas, one of the crimping areas being connected to the hand tool body, and at least one of the crimping areas capable of being alternatively connected to the hand tool body.

According to an embodiment of the present invention, one of the unconnected crimping areas is adapted for an F-type coaxial terminal, a BNC-type coaxial terminal or an RCA-type coaxial terminal.

According to another embodiment of the present invention, one of the unconnected crimping areas is adapted for an IEC type coaxial terminal.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a coaxial connector crimping hand tool according to the present invention.

FIG. 2 is a perspective view of a first embodiment coaxial connector crimping component according to the present invention.

FIG. 3 illustrates a first embodiment coaxial connector crimping component crimping an F-type coaxial terminal according to the present invention.

FIG. 4 illustrates a first embodiment coaxial connector crimping component crimping a BNC-type coaxial terminal according to the present invention.

FIG. 5 illustrates a first embodiment coaxial connector crimping component crimping an RCA-type coaxial terminal according to the present invention.

FIG. 6 illustrates a second embodiment coaxial connector crimping component crimping an IEC-type coaxial terminal according to the present invention.

### DETAILED DESCRIPTION OF THE PREFERRED EMBODIMENT

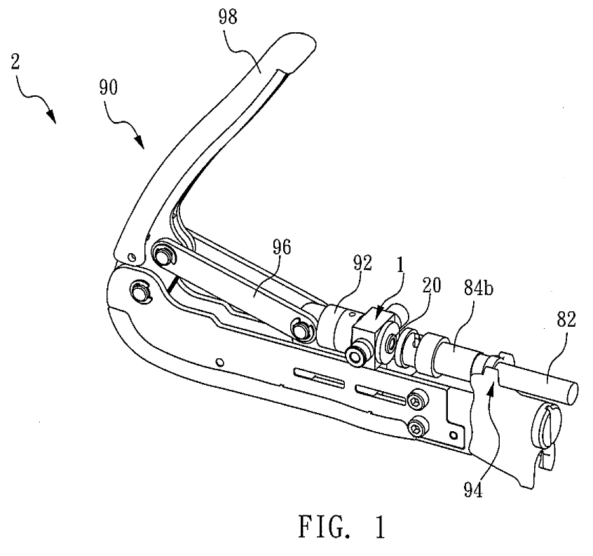

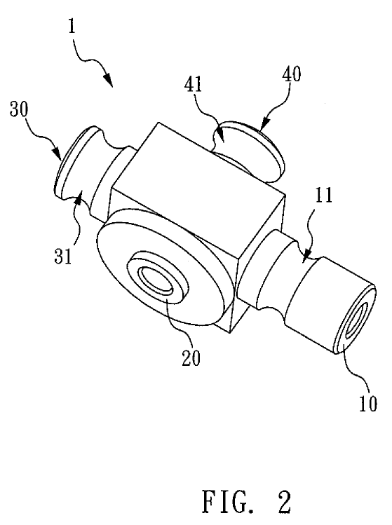

Please refer to both FIG. 1 and FIG. 2. FIG. 1 is a perspective view of a coaxial connector crimping hand tool according to the present invention. FIG. 2 is a perspective view of a first embodiment coaxial connector crimping component according to the present invention. Coaxial cable 82 and a coaxial terminal are originally two individual components; a hand tool 2 of the present invention is used to crimp coaxial cable 82 and the coaxial terminal together; the coaxial terminal may be of various types.

The hand tool 2 comprises a hand tool body 90 and a coaxial connector crimping component 1. The coaxial connector crimping component 1 comprises a plurality of crimping areas 10, 20 and 30, and one of the crimping areas 10, 20 and 30 is connected to the hand tool body 90. The outer diameters of all crimping areas may all, for example, be identical to or different from each other. In this embodiment, the coaxial connector crimping component 1 comprises three crimping areas 10, 20 and 30 for different types of coaxial terminals, and a connector 40 for providing a connection. The shapes of the crimping areas 10, 20 and 30 match up with the different coaxial terminals. The crimping area 10 may be, for example, suitable for an F-type coaxial terminal; the crimping area 20 may be suitable for a BNC-type coaxial terminal, and the crimping area 30 may be suitable for an RCA-type coaxial terminal. The crimping area 10 and the crimping area 30 may be located on two opposite faces of the coaxial connector crimping component 1, and the crimping area 20 and the connector 40 may be located on the other two opposite faces of the coaxial connector crimping component 1.

Since F-type and RCA-type coaxial terminals have similar shapes, the crimping areas 10 and 30 may be designed to have the same outer diameter so that the crimping area 10 or 30 is fixed to the hand tool body 90 with a matched inner diameter. The crimping areas 10 and 30 not can only be used for crimping different types of coaxial terminals but may also be used for connecting to the hand tool body 90.

The outer diameters of the crimping areas may be identical; the other dimensions of the crimping area may also match the coaxial terminal to form a connection. For example, when the center axis of the coaxial terminal to be connected is larger, the center aperture diameter of the matching crimping area is also larger. Furthermore, since the total length of the hand tool 2 is fixed, when the length of the coaxial terminal to be connected is longer, the matching crimping area will be shorter.

The crimping area 20 is suitable for BNC-type coaxial terminals; since this type of terminal has a larger outer diameter, it cannot be fixed onto the hand tool body 90. Therefore, the connector 40 located opposite from the crimping area 20 is used for securing the hand tool body 90, and the connector 40 also has the same identical diameter as the crimping areas 10 and 30.

In this embodiment, the hand tool body 90 comprises a moveable connecting component 92, and the crimping area 10, the crimping area 30 or the connector 40 can be connected to the connecting component 92. The crimping area 10, the crimping area 30 or the connector 40 may be connected to the hand tool body 90 using a plug-in type arrangement.

To insure the coaxial connector crimping component 1 is firmly connected to the connecting component 92, the crimping area 10, the crimping area 30 and the connector 40 may each have a matching structure with that of the connecting component 92 for attachment purposes. In this embodiment, the crimping area 10, the crimping area 30 or the connector 40 may each have a concave area 11, 31, and 41; the connecting component 92 may have a raised area (not shown). Consequently, the crimping area 10, the crimping area 30 or the connector 40 may firmly attach to the connecting component 92.

When the crimping area 10, the crimping area 30 or the connector 40 is firmly attached to the connecting component 92, the other opposite face may be used for crimping the coaxial terminal.

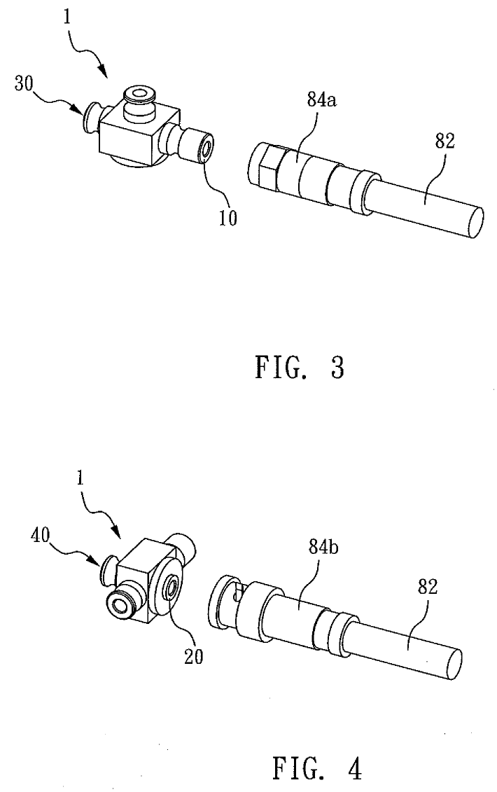

Please refer to FIG. 3. FIG. 3 shows the coaxial connector crimping component of the first embodiment crimping an F-type coaxial terminal. When an F-type coaxial terminal 84a and the coaxial cable 82 are to be crimped together, the crimping area 30 is firmly attached to the connecting component 92 (with reference to FIG. 1), and the crimping area 10 on the opposite face of the crimping area 30 is used for crimping the coaxial cable 82 and an F-type coaxial terminal 84a together.

Please refer to FIG. 4. FIG. 4 shows the coaxial connector crimping component of the first embodiment crimping a BNC-type coaxial terminal. When a BNC-type coaxial terminal 84b and the coaxial cable 82 are to be crimped together, the connector is firmly attached to the connecting component 92 (with reference to FIG. 1), and the crimping area 20 on the opposite face of the connector 40 is used for crimping the coaxial cable 82 and a BNC-type coaxial terminal 84b together.

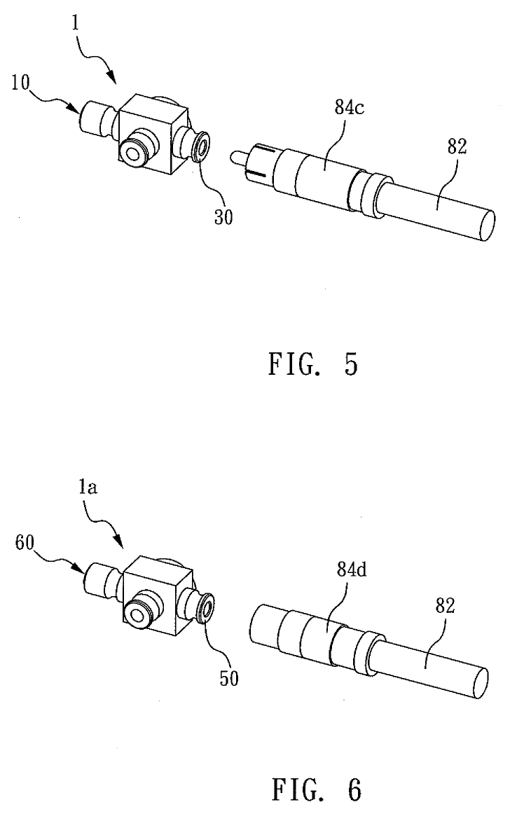

Please refer to FIG. 5. FIG. 5 shows the coaxial connector crimping component of the first embodiment crimping an RCA-type coaxial terminal according to the present invention. When an RCA-type coaxial terminal 84c and the coaxial cable 82 are to be crimped together, the crimping area 10 is firmly attached to the connecting component 92 (with reference to FIG. 1), and the crimping area 30 on the opposite face of the crimping area 10 is used for crimping together the coaxial cable 82 and an RCA-type coaxial terminal 84c.

Please refer to FIG. 6. FIG. 6 shows a second embodiment coaxial connector crimping component crimping an IEC-type coaxial terminal according to the present invention. A coaxial connector crimping component 1a at least comprises a crimping area 50 and a crimping area 60. The shape of the crimping area 50 matches an IEC-type coaxial terminal 84d, and the crimping areas 50 and 60 have the same outer diameter. When an IEC-type coaxial terminal 84d and the coaxial cable 82 are to be crimped together, the crimping area 60 of the coaxial connector crimping component 1a is firmly attached to the connecting component 92 (with reference to FIG. 1), and the crimping area 50 on the opposite face of the crimping area 60 is used for crimping together the coaxial cable 82 and an IEC the coaxial terminal 84d.

The following description explains the movement of the hand tool 2. Please refer to FIG. 1 to FIG. 4. When the coaxial cable 82 and a BNC-type coaxial terminal 84b are to be crimped together, the coaxial terminal 84b is first inserted into the coaxial cable 82, and then the coaxial cable 82 is firmly attached to a brace 94. The connector 40 is fixed to the connecting component 92. When a user applies a force to a handle 98, this force causes the lever 96 to move and push the connecting component 92; the connecting component 92 then moves towards to the coaxial terminal 84. The user continuously pushes until the crimping area 20 of the coaxial connector crimping component 1 is against the coaxial terminal 84b and the coaxial terminal 84b and the coaxial cable 82 are crimped together.

Various types of coaxial terminals in addition to the mentioned four types may be supported. Therefore, the crimping area of the coaxial connector crimping component may also support other types of coaxial terminals other than F-type, BNC-type, RCA-type, and IEC-type terminals. Moreover, various numbers of crimping areas may also be employed; for example, the coaxial connector crimping component may have four or six crimping areas. Furthermore, the crimping area may also be designed for the same type of coaxial terminal, but with different specifications. For example, the crimping areas may all be suitable for F-type coaxial terminals having different lengths. Therefore, various numbers, types and specifications for the crimping area in the present invention may be employed.

Although the present invention has been explained in relation to its preferred embodiment, it is to be understood that many other possible modifications and variations can be made without departing from the spirit and scope of the invention as hereinafter claimed.

What is claimed is:

1. A coaxial connector crimping component capable of connecting to a hand tool body to form a hand tool, the hand tool being used for crimping together a coaxial cable and a coaxial terminal, the coaxial connector crimping component comprising:
a plurality of crimping areas, one of the crimping areas being connected to the hand tool body, and at least one of the crimping areas capable of being alternatively connected to the hand tool body.

2. The coaxial connector crimping component as claimed in claim 1, wherein one of the unconnected crimping areas is adapted for an F-type coaxial terminal.

3. The coaxial connector crimping component as claimed in claim 1, wherein one of the unconnected crimping areas is adapted for a BNC-type coaxial terminal.

4. The coaxial connector crimping component as claimed in claim 1, wherein one of the unconnected crimping areas is adapted for an RCA-type coaxial terminal.

5. The coaxial connector crimping component as claimed in claim 1, wherein one of the unconnected crimping areas is adapted for an IEC-type coaxial terminal.

6. The coaxial connector crimping component as claimed in claim 1, wherein the plurality of crimping areas comprise at least three crimping areas.

7. The coaxial connector crimping component as claimed in claim 1, wherein the hand tool body further comprises a moveable connecting component, and the crimping area connected to the hand tool body is firmly attached to the connecting component.

8. The coaxial connector crimping component as claimed in claim 7, wherein each crimping area and the connecting component respectively comprise a matched raised and concave structure so that each crimping area is adapted for firmly attaching to the connecting component.

9. A hand tool for crimping together a coaxial cable and a coaxial terminal, the hand tool comprising:
a hand tool body;
a coaxial connector crimping component, the coaxial connector crimping component being connected to the hand tool body, the coaxial connector crimping component comprising a plurality of crimping areas, one of the crimping areas being connected to the hand tool body, and at least one of the crimping areas capable of being alternatively connected to the hand tool body.

10. The hand tool as claimed in claim 9, wherein one of the unconnected crimping areas is adapted for an F-type coaxial terminal.

11. The hand tool as claimed in claim 9, wherein one of the unconnected crimping areas is adapted for a BNC-type coaxial terminal.

12. The hand tool as claimed in claim 9, wherein one of the unconnected crimping areas is adapted for an RCA-type coaxial terminal.

13. The hand tool as claimed in claim 9, wherein one of the unconnected crimping areas is adapted for an IEC-type coaxial terminal.

14. The hand tool as claimed in claim 9, wherein the plurality of crimping areas comprise at least three crimping areas.

15. The hand tool as claimed in claim 9, wherein the hand tool body further comprises a moveable connecting component, and the crimping area connected to the hand tool body is firmly attached to the connecting component.

16. The hand tool as claimed in claim 15, wherein each crimping area and the connecting component respectively comprise a matched raised and concave structure so that each crimping area is adapted for firmly attaching to the connecting component.
